(19) United States
(12) Patent Application Publication
(10) Pub. No.: US 2015/0080224 A1
(43) Pub. Date: Mar. 19, 2015

(54) SUPERCONDUCTING MAGNET

(71) Applicant: Sumitomo Electric Industries Ltd., Osaka-shi, Osaka (JP)

(72) Inventors: Takashi Nishimura, Osaka-shi (JP); Takeshi Kato, Osaka-shi (JP)

(73) Assignee: SUMITOMO ELECTRIC INDUSTRIES, LTD., Osaka-shi, Osaka (JP)

(21) Appl. No.: 14/390,158

(22) PCT Filed: May 10, 2013
(86) PCT No.: PCT/JP2013/063141

§ 371 Date: Oct. 2, 2014

(30) Foreign Application Priority Data
May 14, 2012 (JP) 2012-110342
Jan. 25, 2013 (JP) 2013-011941

(51) Int. Cl. H01F 6/06

(52) U.S. Cl. CPC H01F 6/06
USPC 505/211; 335/216

(57) ABSTRACT

A coil unit is formed of an oxide superconducting wire having a surface in a form of a strip and wound. A residual magnetic field restraint unit is disposed in the coil unit. The residual magnetic field restraint unit has a throughhole extending in an axial direction of the coil unit. The residual magnetic field restraint unit is formed of a magnetic substance. A residual magnetic field can thus be restrained.

### TECHNICAL FIELD

The present invention relates to a superconducting magnet, and more specifically to a superconducting magnet having a coil unit formed of an oxide superconducting wire having a surface in the form of a strip and wound.

### BACKGROUND ART

It is known that the intensity of a magnetic field generated from a superconducting magnet is not determined only by a current applied to the magnet and it is also affected by a magnetic field induced by a screening current. For example, Nonpatent Document 1: Y. Yanagisawa et al., “Effect of current sweep reversal on the magnetic field stability for a Bi-2223 superconducting solenoid”, Physica C, 469[22] (2009) 1996-1999 refers to a magnetic field induced by a screening current in a superconducting solenoid using a Bi-2223 superconducting wire in the form of a tape.

### CITATION LIST

### Nonpatent Document

NPD 1: Y. Yanagisawa et al., “Effect of current sweep reversal on the magnetic field stability for a Bi-2223 superconducting solenoid”, Physica C, 469 [22] (2009) 1996-1999

### SUMMARY OF INVENTION

### Technical Problem

Thus, if a current applied to a coil unit of a superconducting magnet is stopped to stop generating a magnetic field, the superconducting magnet is affected by a screening current and thus has a residual magnetic field.

Accordingly, an object of the present invention is to provide a superconducting magnet that can restrain a residual magnetic field.

### Solution to Problem

The present invention provides a superconducting magnet having a coil unit and a residual magnetic field restraint unit. The coil unit is formed of an oxide superconducting wire having a surface in a form of a strip and wound. The residual magnetic field restraint unit is formed of a magnetic substance, disposed in the coil unit, and having a throughhole extending in an axial direction of the coil unit.

The superconducting magnet that is provided with the residual magnetic field restraint unit can restrain a magnetic field in magnitude that is provided while a current applied to the coil unit is stopped, i.e., a residual magnetic field.

Preferably, the magnetic substance has a maximum magnetic permeability equal to or larger than 100. The residual magnetic field restraint unit can thus have a more sufficient magnetic property required to restrain the residual magnetic field. Note that “maximum magnetic permeability” as used herein indicates a maximum value of a relative magnetic permeability of a magnetic substance around room temperature.

Preferably the residual magnetic field restraint unit has an axial length equal to or larger than a width of the surface in the form of the strip of the oxide superconducting wire. This allows the coil unit to have the residual magnetic field restraint unit therein across a unitary width of the oxide superconducting wire.

The residual magnetic field restraint unit may have an axial length equal to or larger than a half of that of the coil unit. The residual magnetic field restraint unit can thus be disposed across the half of the coil unit or larger.

The residual magnetic field restraint unit may have an axial length equal to or larger than that of the coil unit. The residual magnetic field restraint unit can thus be disposed in the coil unit across the coil unit.

The residual magnetic field restraint unit may have an axial length larger than that of the coil unit. The residual magnetic field restraint unit can thus be disposed across the coil unit and also project from the coil unit. The residual magnetic field restraint unit that projects can be easily secured.

The residual magnetic field restraint unit may include a pipe having a wall thickness equal to or larger than 1 mm. The wall thickness equal to or larger than 1 mm allows a residual magnetic field to be more sufficiently restrained.

The residual magnetic field restraint unit may have a first portion having the throughhole, and a second portion spaced from the first portion and surrounding the first portion. This allows a more intense magnetic field to be handled while the residual magnetic field can more effectively be restrained.

The residual magnetic field restraint unit may configure a portion of a container that accommodates the coil unit therein. When the residual magnetic field restraint unit does not configure a portion of the container, the coil unit needs to have therein both the residual magnetic field restraint unit, and the container to be capable of holding its function independently of the residual magnetic field restraint unit. This results in the coil unit having an internal volume occupied by the residual magnetic field restraint unit and the container at an increased ratio. This reduces a space in the coil unit available to allow a magnetic field to be utilized therein, or necessitates increasing the coil unit in size to maintain the space in dimension. In contrast, when the residual magnetic field restraint unit configures a portion of the container, the coil unit has the residual magnetic field restraint unit therein to also have a function as that portion of the container. This allows the coil unit to have its internal volume occupied by the residual magnetic field restraint unit and the container at a reduced ratio. This can increase a space in the coil unit available to allow a magnetic field to be utilized therein, or alternatively, allows the coil unit to be reduced in size while the space can be maintained in dimension.

Note that the residual magnetic field restraint unit configuring a portion of the container means that the residual magnetic field restraint unit configures a portion essential in maintaining a function of the container for accomplishing a purpose of the container. The purpose of the container is to hold the coil unit low in temperature to hold the coil unit in a superconducting state. To accomplish this purpose, when the container holds a liquid having a temperature lower than the room temperature (e.g., liquid nitrogen or liquid helium), the container's function is to hold the liquid in a liquid state for a practically sufficient period of time. Furthermore, to accomplish the above purpose, when the container holds a vacuum for thermal insulation between the exterior and the coil unit, the container's function is to hold the coil unit in the vacuum. In other words, when the container has the residual magnetic field restraint unit removed therefrom and still does not lose its function as the container, it cannot be said that the residual magnetic field configures a portion of the container. For example, when a container having the above described function has the residual magnetic field restraint unit added thereto, it cannot be said that the residual magnetic field configures a portion of the container.

Preferably, in at least one radial direction of the coil unit, the coil unit and the residual magnetic field restraint unit have a common center position. This can prevent a force otherwise caused between the coil unit and the residual magnetic field restraint unit and causing relative displacement therebetween in the radial direction when the coil unit generates a magnetic field.

Preferably, in the axial direction of the coil unit, the coil unit and the residual magnetic field restraint unit have a common center position. This can prevent a force otherwise caused between the coil unit and the residual magnetic field restraint unit and causing relative displacement therebetween in the axial direction when the coil unit generates a magnetic field.

Preferably, the superconducting magnet further includes a shield formed of a magnetic substance and having a hollow portion to accommodate the coil unit therein, and in at least one radial direction of the coil unit the coil unit and the shield have a common center position. This can prevent a force otherwise caused between the coil unit and the shield and causing relative displacement therebetween in the radial direction when the coil unit generates a magnetic field.

Preferably, the superconducting magnet further includes a shield formed of a magnetic substance and having a hollow portion to accommodate the coil unit therein, and in the axial direction of the coil unit the coil unit and the shield have a common center position. This can prevent a force otherwise caused between the coil unit and the shield and causing relative displacement therebetween in the axial direction when the coil unit generates a magnetic field.

### Advantageous Effect of Invention

The present invention can thus restrain a residual magnetic field.

### BRIEF DESCRIPTION OF DRAWINGS

FIG. 1 is a cross section schematically showing a configuration of a superconducting magnet in a first embodiment of the present invention.

FIG. 2 is a partial enlarged view of FIG. 1 and a schematic cross section taken along a line II-II indicated in FIG. 3.

FIG. 3 is generally a plan view of FIG. 2.

FIG. 4 is a perspective view schematically showing a configuration of a double pancake coil that a coil unit included in the superconducting magnet of FIG. 1 has.

FIG. 5 is a schematic cross section taken along a line V-V shown in FIG. 4.

FIG. 6 is a partial perspective view schematically showing a configuration of an oxide superconducting wire used to form the double pancake coil of FIG. 4.

FIG. 7 is a cross section schematically showing a configuration of a superconducting magnet in a second embodiment of the present invention.

FIG. 8 is a cross section schematically showing a configuration of a superconducting magnet in a third embodiment of the present invention.

FIG. 9 is a cross section schematically showing a configuration of a residual magnetic field restraint unit that a superconducting magnet in a fourth embodiment of the present invention has.

FIG. 10 is a schematic cross section taken along a line X-X shown in FIG. 9.

FIG. 11 is a graph schematically representing a relationship between the residual magnetic field restraint unit in thickness and number, and a residual magnetic field.

FIG. 12 shows a magnetic field distribution of a comparative example, as compared with an inventive example 1.

FIG. 13 shows a magnetic field distribution in inventive example 1 when the residual magnetic field restraint unit has a thickness of 0.5 mm.

FIG. 14 shows a magnetic field distribution in inventive example 1 when the residual magnetic field restraint unit has a thickness of 1.0 mm.

FIG. 15 shows a magnetic field distribution of a comparative example, as compared with an inventive example 2.

FIG. 16 shows a magnetic field distribution in inventive example 2 when the residual magnetic field restraint unit has a thickness of 1 mm.

FIG. 17 shows a magnetic field distribution in inventive example 2 when the residual magnetic field restraint unit has a thickness of 10 mm.

FIG. 18 graphically represents in an inventive example 3 a residual magnetic field and a residual magnetic field reduction rate versus the residual magnetic field restraint unit in thickness.

FIG. 19 is a graph representing a magnetization curve of SS400 used in a simulation.

FIG. 20 is a cross section schematically showing a configuration of a superconducting magnet in a fifth embodiment of the present invention.

FIG. 21 is a cross section schematically showing a configuration of a superconducting coil that a superconducting magnet in a sixth embodiment of the present invention has.

FIG. 22 is generally a plan view of FIG. 21.

FIG. 23 is a cross section schematically showing a configuration of a superconducting coil that a superconducting magnet in a seventh embodiment of the present invention has.

FIG. 24 is generally a plan view of FIG. 23.

FIG. 25 is a schematic cross section showing an exemplary variation of FIG. 23.

### DESCRIPTION OF EMBODIMENTS

Hereinafter reference will be made to the drawings to describe the present invention in embodiments. In the figures, identical or corresponding components are identically denoted and will not be described repeatedly.

### First Embodiment

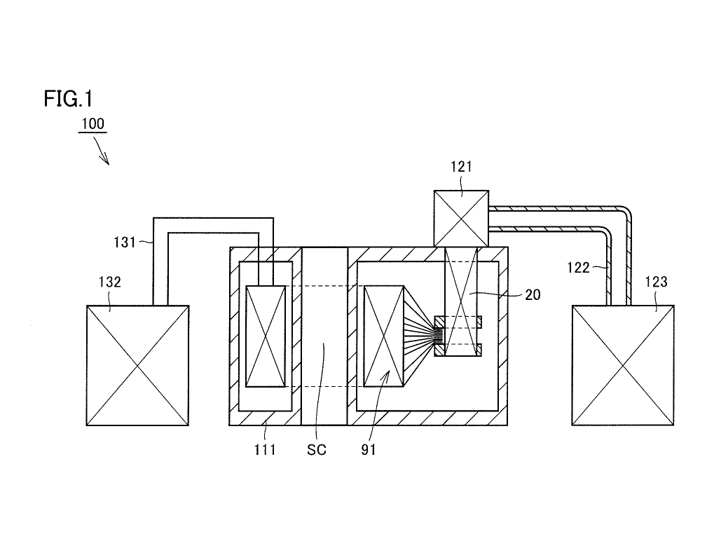

With reference to FIG. 1, the present embodiment provides a superconducting magnet 100 having a superconducting coil 91, a thermal insulation container 111, a cooling device 121, a hose 122, a compressor 123, a cable 131, and a power supply 132. Thermal insulation container 111 has superconducting coil 91 accommodated therein. In the present embodiment, a material (not shown) to be exposed to a magnetic field is accommodated in a magnetic field application region SC provided in thermal insulation container 111 therethrough. Cooling device 121 has a cooling head 20.

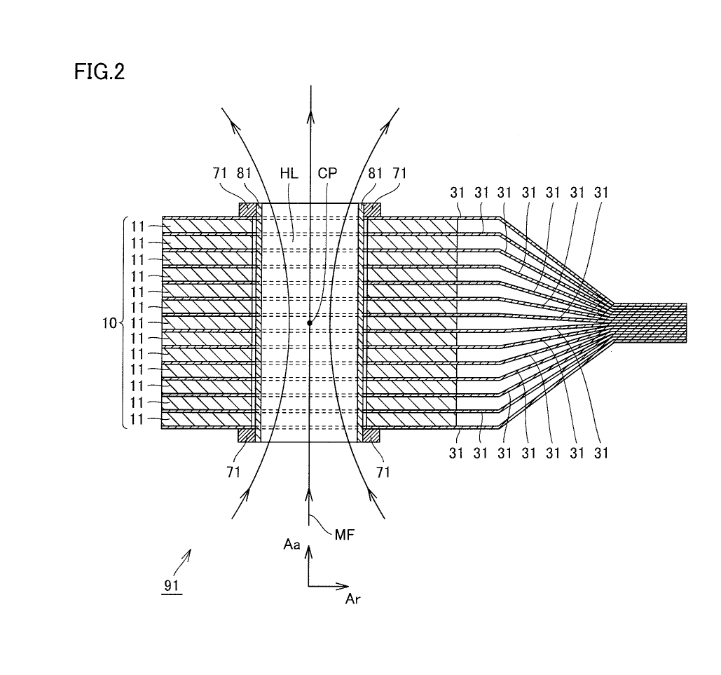

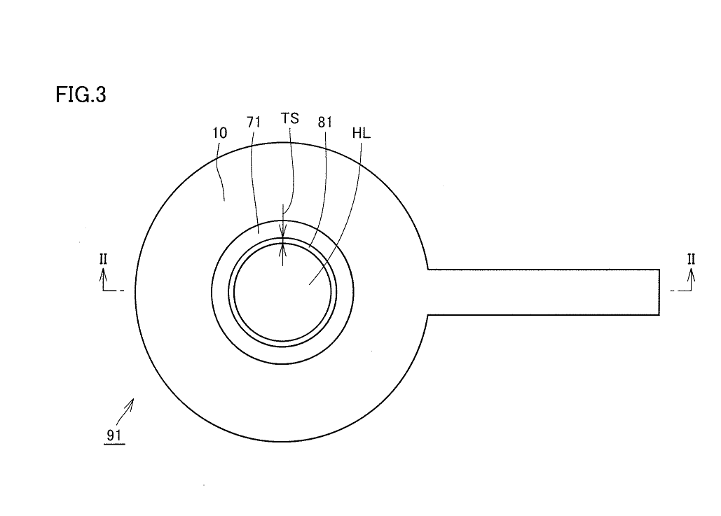

With reference to FIG. 2 and FIG. 3, superconducting coil 91 has a coil unit 10, a pipe unit 81 (or a residual magnetic field restraint unit), and an attachment 71.

Coil unit 10 has a double pancake coil 11 and a heat exchanger plate 31, Double pancake coil 11 is stacked in an axial direction Aa of coil unit 10 on one another in layers. A radial direction Ar corresponds to a direction perpendicular to axial direction Aa. Cooling device 121 has cooling head 20 coupled with double pancake coil 11 via heat exchanger plate 31 to be able to cool double pancake coil 11. Heat exchanger plate 31 is formed of a nonmagnetic material specifically having a maximum magnetic permeability smaller than 100. Furthermore, heat exchanger plate 31 is preferably formed of material having large thermal conductivity and large flexibility. Heat exchanger plate 31 is formed for example of aluminum (Al) or copper (Cu). Al or Cu preferably has a purity of 99.9% or larger. A magnetic flux MF is generated as a superconducting current flows through double pancake coil 11 thus cooled.

Pipe unit 81 has a throughhole HL extending in axial direction Aa of coil unit 10. Pipe unit 81 preferably includes a pipe having a wall thickness equal to or larger than 1 mm. Pipe unit 81 is disposed in coil unit 10. Preferably, pipe unit 81 is disposed to have a center to match a center CP of coil unit 10.

Pipe unit 81 is formed of a magnetic substance, and specifically has a maximum magnetic permeability equal to or larger than 100. Pipe unit 81 is formed of a magnetic substance such as iron, electromagnetic soft iron, electromagnetic steel, permalloy alloy, or amorphous magnetic alloy. Note that iron generally has a maximum magnetic permeability of approximately 5000.

Pipe unit 81 has a length in axial direction Aa equal to or larger than a width of a surface in the form of a strip SF of oxide superconducting wire 14 (i.e., a half of a height of each double pancake coil 11 shown in FIG. 2). Preferably, pipe unit 81 has a length in axial direction Aa equal to or larger than the height of each double pancake coil 11. Pipe unit 81 may have a length in axial direction Aa equal to or larger than a half of that of coil unit 10 in axial direction Aa. More preferably, pipe unit 81 has a length in axial direction Aa equal to or larger than that of coil unit 10 in axial direction Aa. Still more preferably, as shown in FIG. 2, pipe unit 81 has a length in axial direction Aa larger than that of coil unit 10 in axial direction Aa.

Pipe unit 81 is attached to coil unit 10 via attachment 71. In the present embodiment, a portion of pipe unit 81 that projects from coil unit 10 is secured to coil unit 10 by attachment 71. Preferably, attachment 71 is formed of a non-magnetic substance, and specifically has a maximum magnetic permeability smaller than 100.

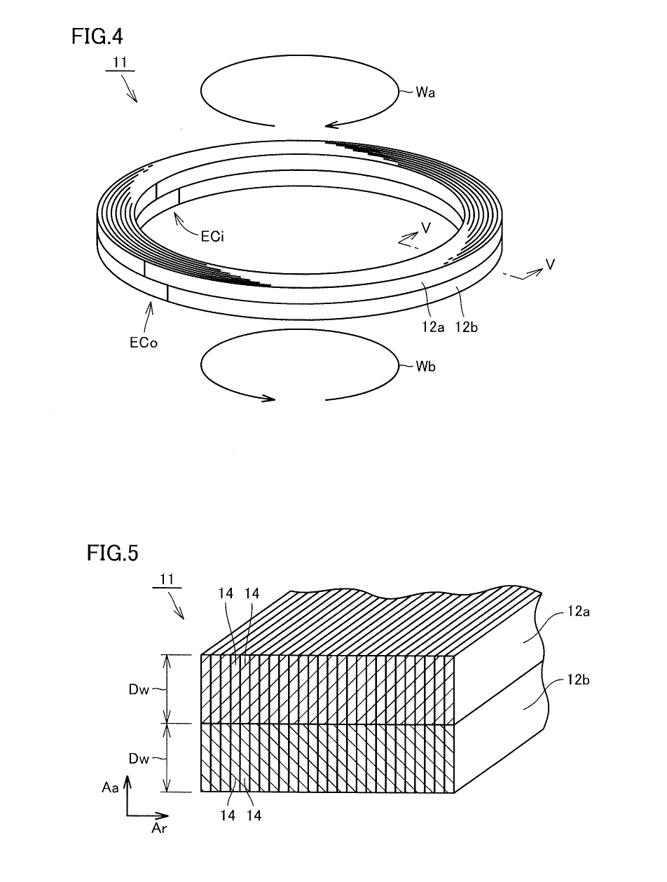

Furthermore, with reference to FIG. 4 and FIG. 5, double pancake coil 11 configuring coil unit 10 each has pancake coils 12a and 12b. Pancake coils 12a and 12b are stacked on each other in layers. Pancake coils 12a and 12b are each formed of oxide superconducting wire 14 wound.

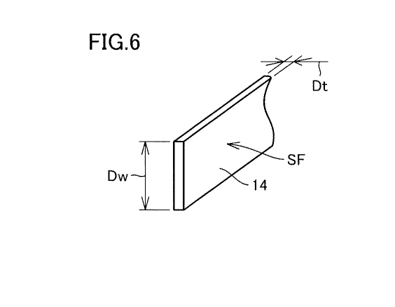

Furthermore, with reference to FIG. 6, oxide superconducting wire 14 is in the form of a tape, in other words, in the form of a strip, and accordingly has a surface in the form of the strip SF. The surface in the form of the strip SF has a width Dw in axial direction Aa, and a thickness Dt smaller than width Dw. For example, thickness Dt is approximately 0.2 mm and width Dw is approximately 4 mm. For example, oxide superconducting wire 14 has a Bi based superconductor extending along oxide superconducting wire 14, and a sheath that covers the superconductor. The sheath is formed of silver or a silver alloy, for example. Oxide superconducting wire 14 has a property allowing alternating-current loss to be increased as a magnetic field perpendicular to the surface in the form of the strip SF (i.e., a perpendicular magnetic field) is increasingly applied.

Pancake coils 12a and 12b have oxide superconducting wire 14 wound in opposite directions Wa and Wb, respectively. Pancake coil 12a has an inner circumferential side with oxide superconducting wire 14 having an end ECi located thereon, and so does pancake coil 12b, and pancake coils 12a and 12b have their respective ends ECis electrically connected to each other. Accordingly, pancake coils 12a and 12b are connected to each other in series between an end portion ECo of oxide superconducting wire 14 located on an outer circumferential side of pancake coil 12a and an end portion ECo of oxide superconducting wire 14 located on an outer circumferential side of pancake coil 12b. Furthermore, double pancake coils 11 adjacent to each other (vertically in FIG. 2) have their respective ends ECos electrically connected to each other. Double pancake coils 11 are thus connected to one another in series.

The present embodiment provides pipe unit 81 (see FIG. 2) to allow a magnetic field to be restrained in magnitude that is provided while a current applied to coil unit 10 is stopped, i.e., a residual magnetic field. Preferably, the magnetic substance has a maximum magnetic permeability equal to or larger than 100. Pipe unit 81 can thus have a more sufficient magnetic property required to restrain the residual magnetic field. An example to restrain the residual magnetic field will be described hereinafter.

Preferably, pipe unit 81 has a length in axial direction Aa (i.e., a vertical length in FIG. 2) equal to or larger than width Dw of the surface in the form of the strip SF of oxide superconducting wire 14 (see FIG. 5). This allows coil unit 10 to have pipe unit 81 therein across width Dw of oxide superconducting wire 14. Pipe unit 81 may have a length in axial direction Aa equal to or larger than a half of that of coil unit 10 in axial direction Aa. Pipe unit 81 can thus be disposed across a half of coil unit 10 or larger. Pipe unit 81 may have a length in axial direction Aa equal to or larger than that of coil unit 10 in axial direction Aa. Pipe unit 81 can thus be disposed in coil unit 10 across coil unit 10.

Pipe unit 81 may have a length in axial direction Aa larger than that of coil unit 10 in axial direction Aa. Pipe unit 81 can thus be disposed across coil unit 10 and also project from coil unit 10. Pipe unit 81 that projects can be easily secured via attachment 71 (see FIG. 2).

Pipe unit 81 may also include a pipe having a wall thickness TS (see FIG. 3) equal to or larger than 1 mm. Wall thickness TS equal to or larger than 1 mm allows the residual magnetic field to be more sufficiently restrained.

### Second Embodiment

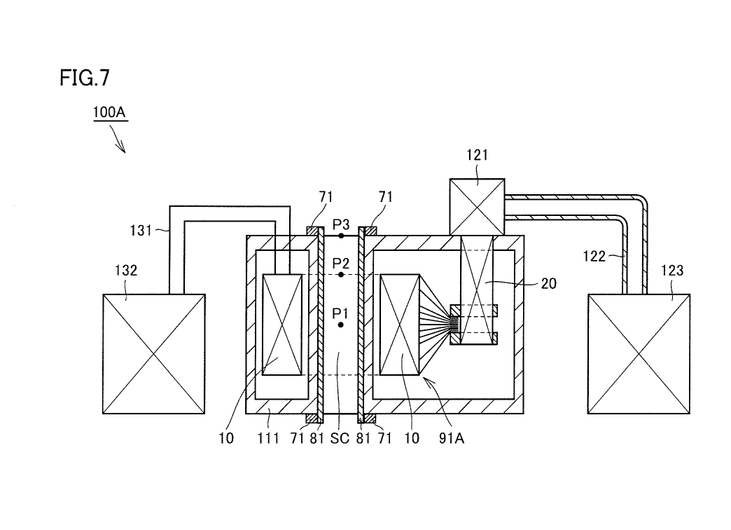

With reference to FIG. 7, the present embodiment provides a superconducting magnet 100A having a superconducting coil 91A and pipe unit 81. Superconducting coil 91A corresponds in configuration to superconducting coil 91 (see FIG. 2) having pipe unit 81 eliminated therefrom. Instead, pipe unit 81 is external to thermal insulation container 111 along a side wall of magnetic field application region SC. In the present embodiment, pipe unit 81 has an end projecting from magnetic field application region SC. Furthermore, pipe unit 81 has the end attached to thermal insulation container 111 via attachment 71.

Note that the remainder in configuration is substantially identical to that of the first embodiment, and accordingly, identical or corresponding components are identically denoted and will not be described repeatedly.

### Third Embodiment

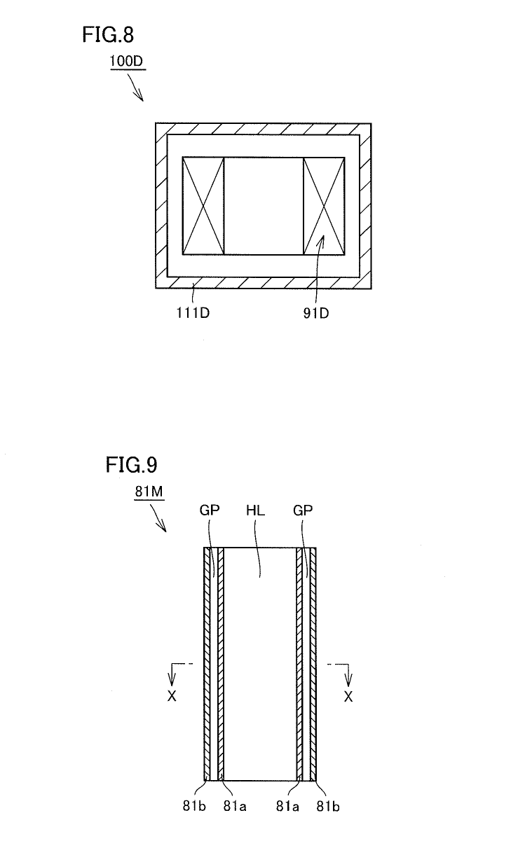

With reference to FIG. 8, the present embodiment provides a superconducting magnet 100D having a superconducting coil 91D and a thermal insulation container 111D. Superconducting coil 91D corresponds in configuration to superconducting coil 91 having heat exchanger plate 31 eliminated therefrom. Thermal insulation container 111D is configured to be capable of receiving liquid nitrogen or a similar coolant. The coolant cools superconducting coil 91D. In other words, in the present embodiment, coil unit 10 can be cooled directly by the coolant, rather than cooling device 121 (see FIG. 2). Note that the remainder in configuration is substantially identical to that of the first embodiment, and accordingly, identical or corresponding components are identically denoted and will not be described repeatedly.

### Fourth Embodiment

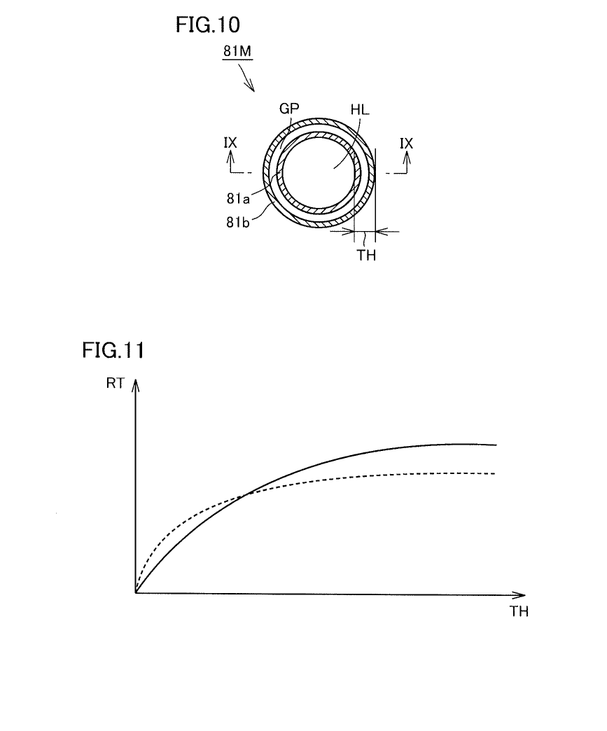

With reference to FIG. 9 and FIG. 10, the present embodiment provides a superconducting magnet having pipe unit 81 replaced with a pipe unit 81M. Pipe unit 81M has an inner circumferential pipe 81a (or a first portion) and an outer circumferential pipe 81b (or a second portion). Inner circumference pipe 81a has a throughhole HL. Outer circumferential pipe 81b is spaced from and thus surrounds inner circumference pipe 81a. Inner circumferential pipe 81a and outer circumferential pipe 81b have an outer surface and an inner surface, respectively, with a gap GP therebetween. In other words, pipe unit 81M has an outermost surface and an innermost surface with a thickness TH (see FIG. 10) therebetween, and that portion of thickness TH is provided with gap GP. Note that the remainder in configuration is substantially identical to that of any of the first to third embodiments, and accordingly, identical or corresponding components are identically denoted and will not be described repeatedly.

FIG. 11 represents how the pipe unit contributes to a residual magnetic field reduction rate RT with and without gap GP, as indicated by solid and broken lines, respectively. When thickness TH is sufficiently large, the pipe unit with gap GP as described in the present embodiment allows the residual magnetic field to be reduced more effectively. When a more intense magnetic field is handled, it is preferable to sufficiently increase thickness TH in view of avoiding magnetically saturating the pipe unit, and accordingly, it is preferable to provide gap GP as described in the present embodiment. The more intense magnetic field can thus be handled while the residual magnetic field can more effectively be restrained.

Note that while the present embodiment has been described for pipe unit 81M having a dual structure formed of inner circumference pipe 81a and outer circumferential pipe 81b, a multi-structure formed of three or more pipes may instead be used. A more intense magnetic field can thus be handled while a residual magnetic field can more effectively be restrained.

Furthermore, gap GP may have introduced therein a filler (not shown) formed of a non-magnetic substances. This allows inner circumference pipe 81a and outer circumferential pipe 81b to be secured to each other. Furthermore, this can also prevent an intense magnetic field from displacing and thus bringing inner circumference pipe 81a and outer circumferential pipe 81b into contact with each other. Furthermore, a member which is substantially the same as attachment 71 (see FIG. 2 or FIG. 7) may be used to secure each of inner circumference pipe 81a and outer circumferential pipe 81b. In that case, the filler may not be used.

### Fifth Embodiment

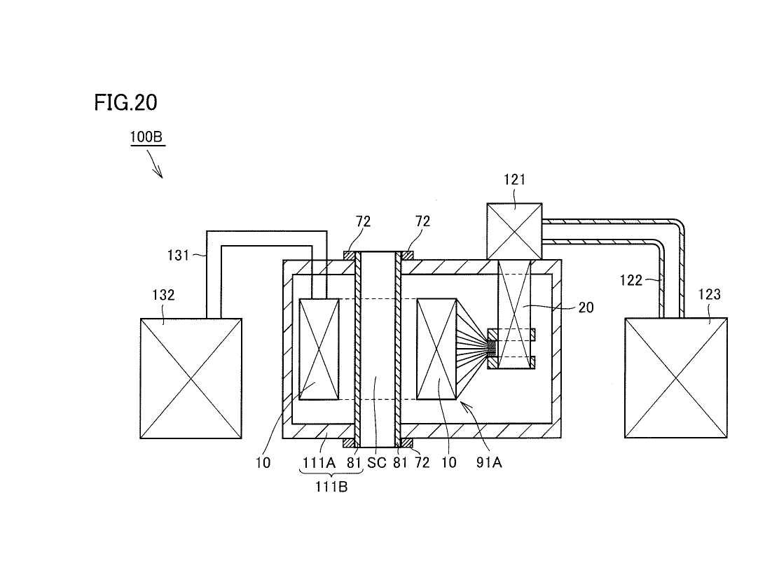

With reference to FIG. 20, the present embodiment provides a superconducting magnet 100B having a thermal insulation container 111B (or a container) that has accommodated therein coil unit 10 of superconducting coil 91A. Thermal insulation container 111B is configured of a body unit 111A and pipe unit 81. Accordingly, pipe unit 81 configures a portion of thermal insulation container 111B.

Note that pipe unit 81 configuring a portion of thermal insulation container 111B means that a portion essential in maintaining a function of thermal insulation container 111B for accomplishing a purpose of thermal insulation container 111B is configured by pipe unit 81. The purpose of thermal insulation container 111B is to hold coil unit 10 low in temperature to hold coil unit 10 in a superconducting state. To accomplish this purpose, holding coil unit 10 in a vacuum to hold a vacuum for thermal insulation between the exterior and coil unit 10 is the function of thermal insulation container 111B. In FIG. 20, magnetic field application region SC in communication with the exterior is at least partially isolated from the interior of thermal insulation container 111B only by pipe unit 81. Accordingly, if pipe unit 81 should be removed, thermal insulation container 111B will lose the vacuum therein and hence its function as a vacuum container.

When pipe unit 81 does not configure a portion of thermal insulation container 111, as described in the second embodiment (see FIG. 7), coil unit 10 needs to have therein both pipe unit 81 and thermal insulation container 111 capable of holding its function independently of pipe unit 81. This results in superconducting coil 91A having an internal volume occupied by pipe unit 81 and thermal insulation container 111 at an increased ratio. This reduces a space in superconducting coil 91A available to allow a magnetic field to be utilized therein, which corresponds to magnetic field application region SC, or necessitates increasing superconducting coil 91A in size to maintain the space in dimension.

In contrast, the present embodiment allows superconducting coil 91A to have pipe unit 81 inside to also have a function as a portion of thermal insulation container 111B. This allows superconducting coil 91A to have its internal volume occupied by thermal insulation container 111B at a reduced ratio. As a result, magnetic field application region SC can be increased in size, or alternatively, superconducting coil 91A can be reduced in size while magnetic field application region SC can be maintained in size.

Note that thermal insulation container 111B may have an attachment 72 for attaching pipe unit 81 to body unit 111A. Attachment 72 may have an O ring in contact with body unit 111A to hermetically hold thermal insulation container 111B.

Furthermore, while the present embodiment employs thermal insulation container 111B having a function as a vacuum container, the container is not limited to the vacuum container, and it may be any container that can accomplish the purpose of holding coil unit 10 low in temperature to hold coil unit 10 in a superconducting state. For example, a container holding a liquid having a temperature lower than the room temperature (e.g., liquid nitrogen or liquid helium) may be used. Such a container is only required to hold the liquid in a liquid state for a practically sufficient period of time.

### Sixth Embodiment

The present embodiment provides a superconducting magnet substantially similar in configuration to superconducting magnet 100 of the first embodiment (see FIG. 1), and furthermore, has coil unit 10 and pipe unit 81 in a particular positional relationship relative to each other. Hereinafter, this positional relationship will be described.

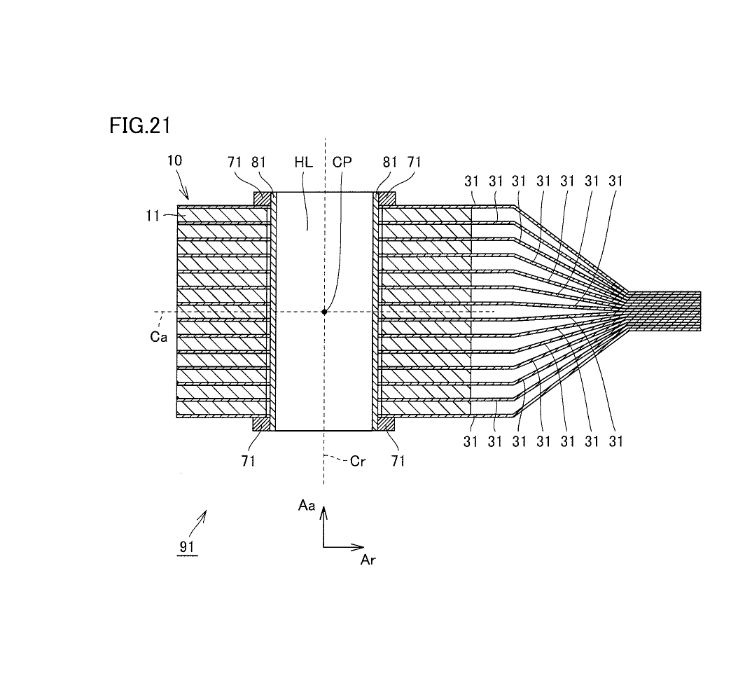

With reference to FIG. 21, coil unit 10 and pipe unit 81 have a common center position Ca in axial direction Aa of coil unit 10. This can prevent a force otherwise caused between coil unit 10 and pipe unit 81 and causing relative displacement therebetween in axial direction Aa when coil unit 10 generates a magnetic field.

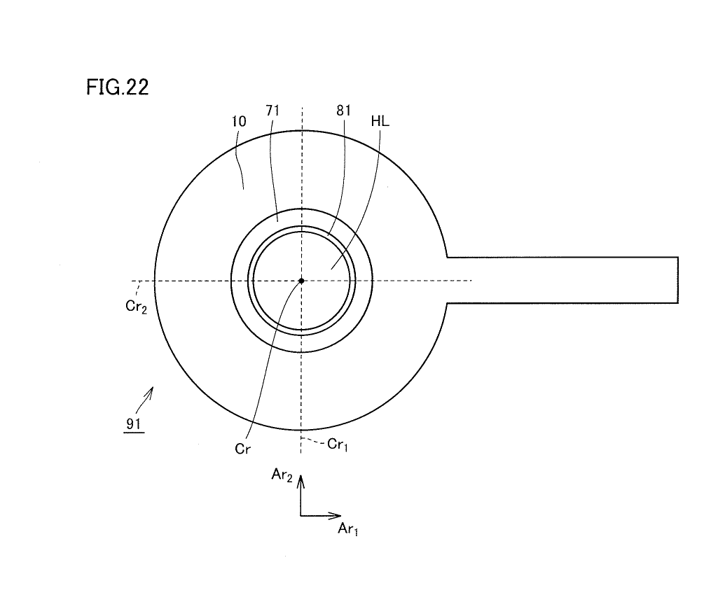

Furthermore, with reference to FIG. 22, coil unit 10 and pipe unit 81 have a common center position Cr₁ in one radial direction Ar of coil unit 10 (see FIG. 21), or a radial direction Ar₁ (or at least one radial direction). A virtual axis extending in radial direction Ar₁ and passing through center position Cr₁, as indicated in FIG. 22 by a broken line, is an axis of symmetry of each of coil unit 10 and pipe unit 81. This can prevent a force otherwise caused between coil unit 10 and pipe unit 81 and causing relative displacement therebetween in radial direction Ar₁ when coil unit 10 generates a magnetic field. Furthermore, coil unit 10 and pipe unit 81 have a common center position Cr₂ in one radial direction Ar of coil unit 10 (see FIG. 21), or a radial direction Ar₂ (or at least one radial direction). A virtual axis extending in radial direction Ar₂ and passing through center position Cr₂, as indicated in FIG. 22 by a broken line, is an axis of symmetry of each of coil unit 10 and pipe unit 81. This can prevent a force otherwise caused between coil unit 10 and pipe unit 81 and causing relative displacement therebetween in radial direction Ar₂ when coil unit 10 generates a magnetic field.

The two axes of symmetry (or the two broken lines shown in FIG. 22) intersect at a center point Cr. As shown, coil unit 10 and pipe unit 81 have center point Cr commonly, as seen in a plan view. This can prevent a force otherwise caused between coil unit 10 and pipe unit 81 and causing relative displacement therebetween in radial direction Ar in general when coil unit 10 generates a magnetic field.

Note that coil unit 10 and pipe unit 81 may not share all of center positions Ca, Cr₁ and Cr₂, and may instead share only one or two thereof.

Furthermore, an error is tolerated that is of such an extent that a magnetic circuit's disorder in symmetry attributed to a positional displacement of coil unit 10 and pipe unit 81 does not pose a problem when coil unit 10 and pipe unit 81 have a common center position in a direction. Specifically, the coil unit's dimensional error in that direction is preferably approximately 10% or smaller, more preferably approximately 5% or smaller.

### Seventh Embodiment

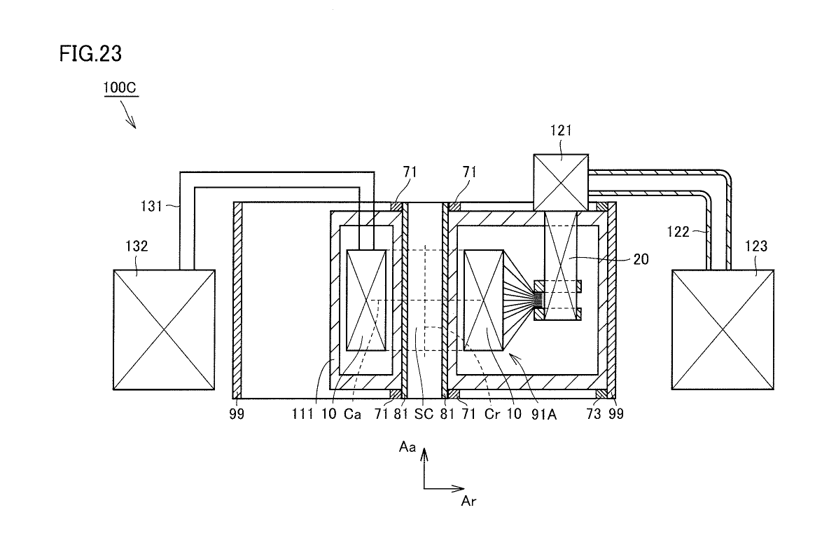

With reference to FIG. 23, the present embodiment provides a superconducting magnet 100C corresponding in configuration to superconducting magnet 100A (see FIG. 7) plus a passive shield 99 (or a shield). Passive shield 99 is provided to prevent unwanted magnetic field leakage external to superconducting magnet 100C. Passive shield 99 has a hollow portion that accommodates coil unit 10 therein, and for example is cylindrical in geometry. Passive shield 99 is formed of a magnetic substance. Preferably, the magnetic substance has a maximum magnetic permeability equal to or larger than 100. Passive shield 99 is secured to thermal insulation container 111. This can be done for example via an attachment 73.

In axial direction Aa of coil unit 10, coil unit 10 and passive shield 99 have common center position Ca. This can prevent a force otherwise caused between coil unit 10 and passive shield 99 and causing relative displacement therebetween in axial direction Aa when coil unit 10 generates a magnetic field.

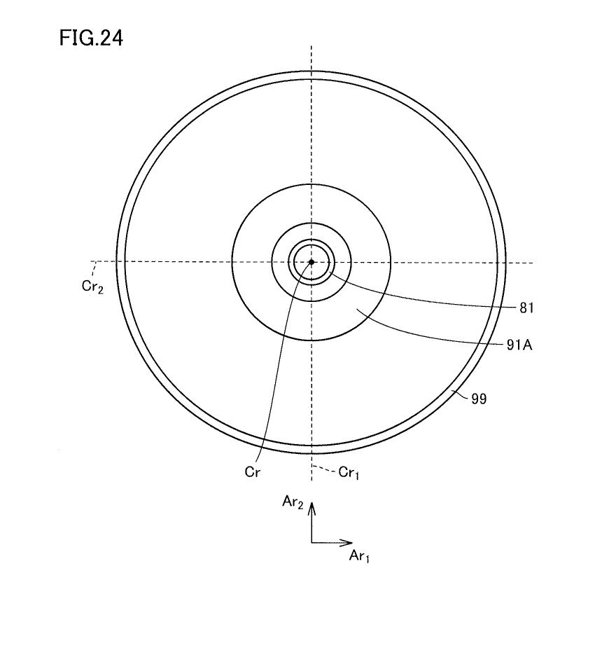

Furthermore, with reference to FIG. 24, coil unit 10 and passive shield 99 have common center position Cr₁ in one radial direction Ar of coil unit 10 (see FIG. 23), or radial direction Ar₁ (or at least one radial direction). A virtual axis extending in radial direction Ar₁ and passing through center position Cr₁, as indicated in FIG. 24 by a broken line, is an axis of symmetry of each of coil unit 10 and passive shield 99. This can prevent a force otherwise caused between coil unit 10 and passive shield 99 and causing relative displacement therebetween in radial direction Ar₁ when coil unit 10 generates a magnetic field. Furthermore, coil unit 10 and passive shield 99 have common center position Cr₂ in one radial direction Ar of coil unit 10 (see FIG. 23), or radial direction Ar₂ (or at least one radial direction). A virtual axis extending in radial direction Ar₂ and passing through center position Cr₂, as indicated in FIG. 24 by a broken line, is an axis of symmetry of each of coil unit 10 and passive shield 99. This can prevent a force otherwise caused between coil unit 10 and passive shield 99 and causing relative displacement therebetween in radial direction Ar₂ when coil unit 10 generates a magnetic field.

The two axes of symmetry (or the two broken lines shown in FIG. 24) intersect at center point Cr. As shown, coil unit 10 and passive shield 99 have center point Cr commonly, as seen in a plan view. This can prevent a force otherwise caused between coil unit 10 and passive shield 99 and causing relative displacement therebetween in radial direction Ar in general when coil unit 10 generates a magnetic field.

Note that coil unit 10 and passive shield 99 may not share all of center positions Ca, Cr₁ and Cr₂, and may instead share only one or two thereof.

Furthermore, when the superconducting magnet of the sixth embodiment is provided with passive shield 99 arranged as described above, it is enhanced in symmetry as a magnetic circuit. This can further prevent a force otherwise caused between coil unit 10, pipe unit 81 and passive shield 99 and causing relative displacement therebetween.

Furthermore, an error is tolerated that is of such an extent that the magnetic circuit's disorder in symmetry attributed to a positional displacement of coil unit 10 and passive shield 99 does not pose a problem when coil unit 10 and passive shield 99 have a common center position in a direction. Specifically, the coil unit's dimensional error in that direction is preferably approximately 10% or smaller, more preferably approximately 5% or smaller.

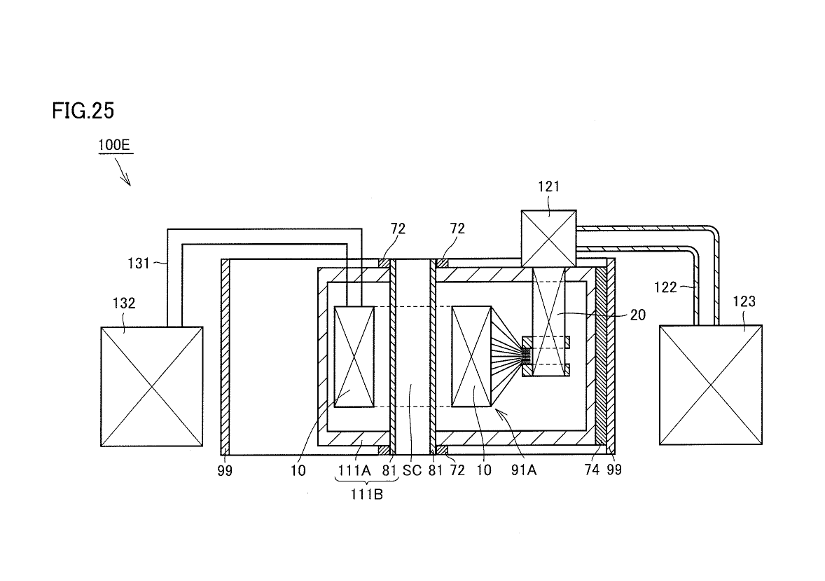

Note that the attachment that secures passive shield 99 is not necessarily limited to what is disposed on the upper and lower surfaces of thermal insulation container 111 (i.e., those surfaces which traverse axial direction Aa), such as attachment 73 for superconducting magnet 100C (see FIG. 23). Attachment 74 may be disposed between thermal insulation container 111B and passive shield 99, such as an attachment 74 for a superconducting magnet 100E (see FIG. 25)

### Example 1

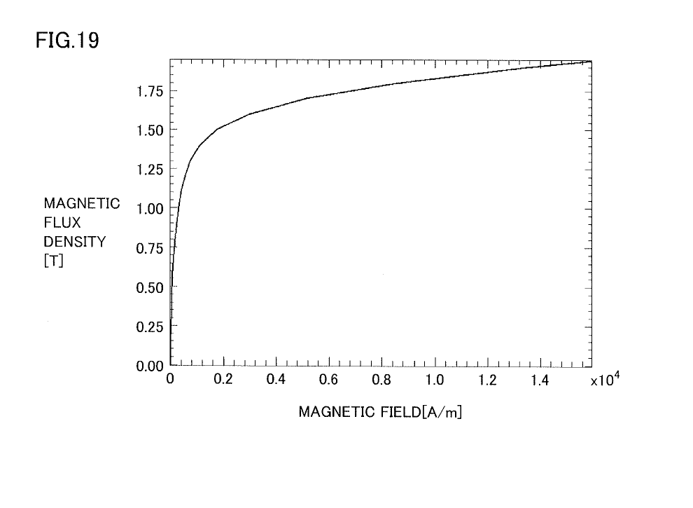

An inventive example corresponding to the third embodiment (i.e., having pipe unit 81 shown in FIG. 2) and a comparative example (excluding pipe unit 81) provided residual magnetic fields, respectively, through a simulation in the finite element method, as will be described hereinafter. In the simulation, double pancake coil 11 (see FIG. 4) had an inner diameter of 130 mm, an outer diameter of 210 mm, a height of 9 mm, and 280 turns. Furthermore, coil unit 10 (see FIG. 2) had 10 double pancake coils 11 stacked in layers. Pipe unit 81 was assumed to be formed of SS400 having a magnetization curve shown in FIG. 19 (according to Japanese Industrial Standards (JIS)). Furthermore, assuming that the coolant was liquid nitrogen, it was assumed that thermal insulation container 111D had an internal temperature of 77 K, and a current in the ON state was set to 25 A. A magnetic field in the ON state was set to 0.5 T.

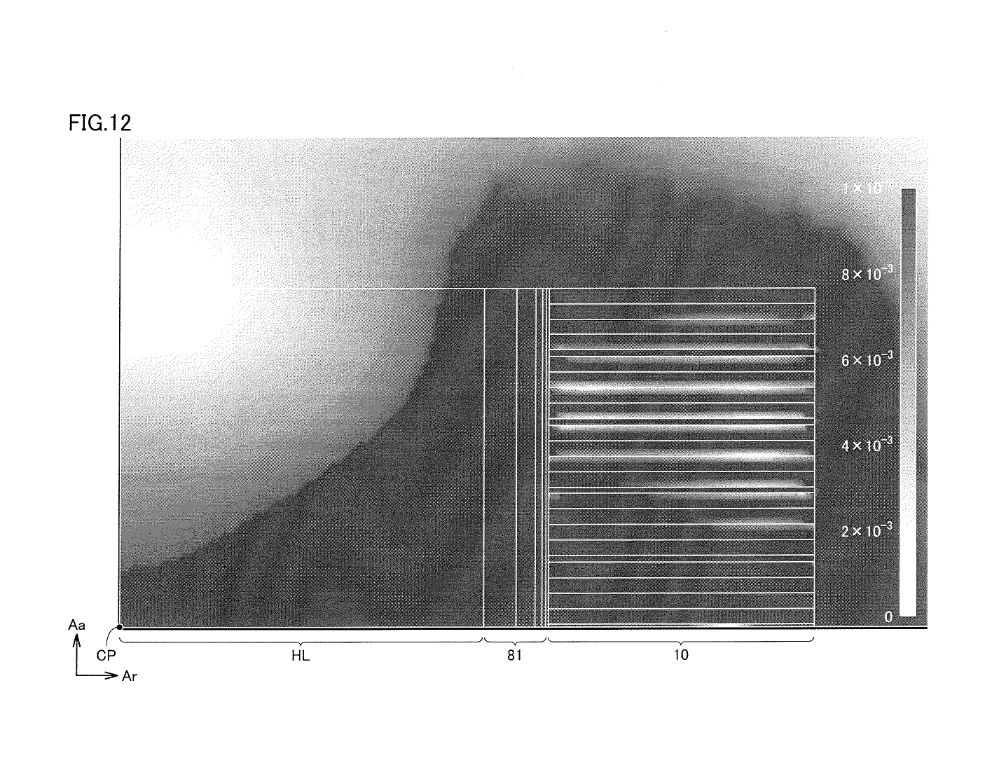

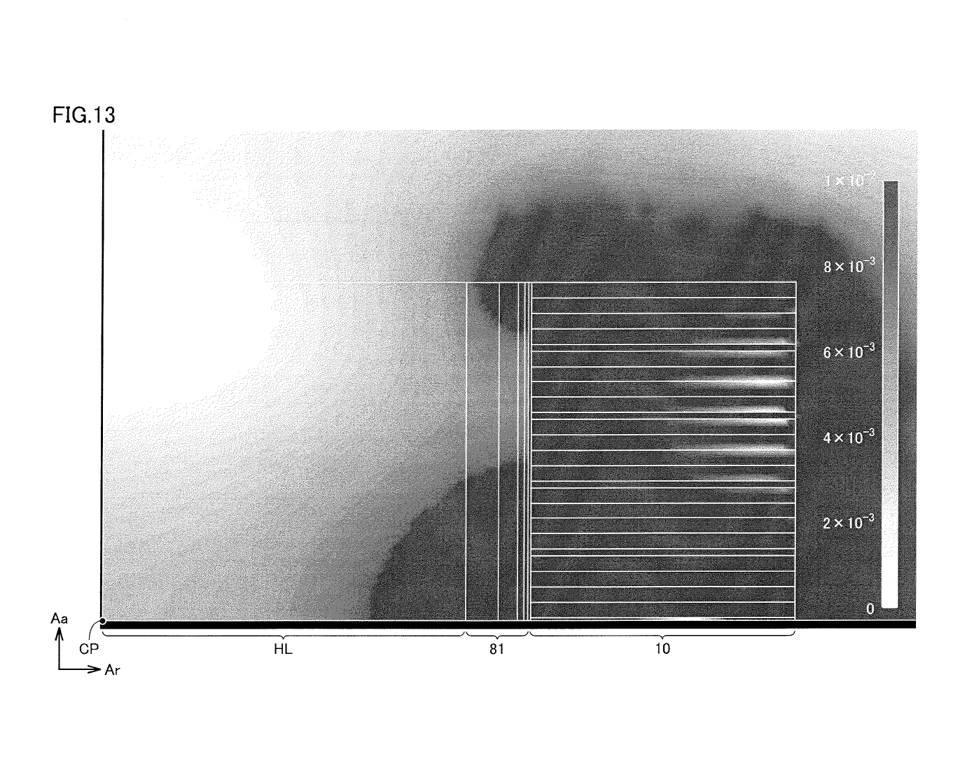

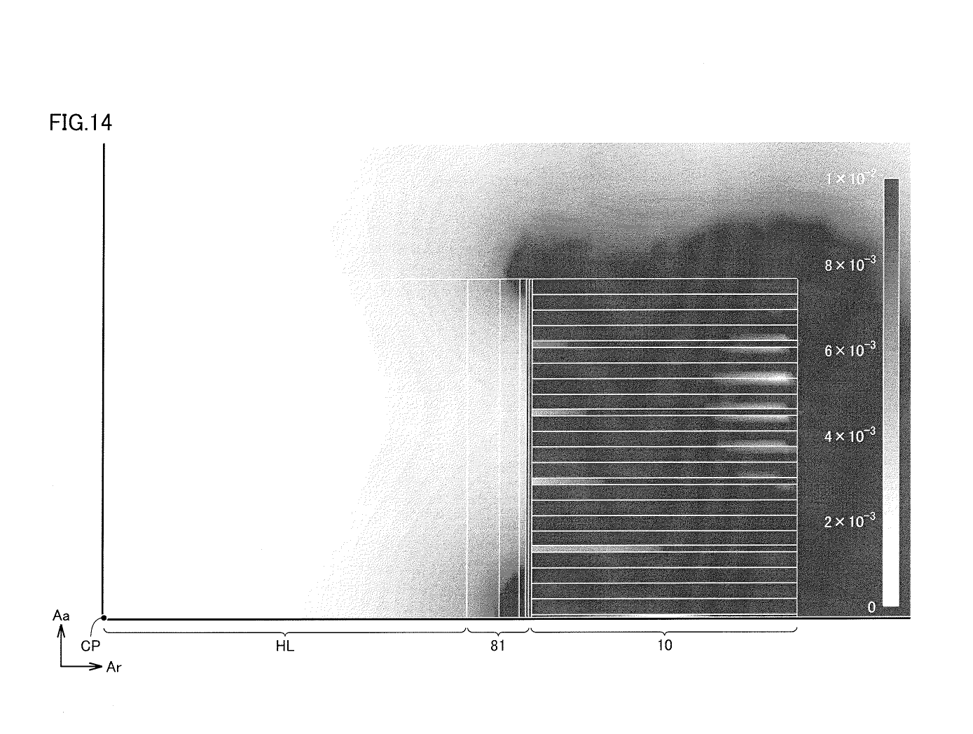

FIGS. 12, 13 and 14 represent a distribution of a residual magnetic field (T) corresponding to the comparative example (excluding the pipe), that of the residual magnetic field corresponding to an inventive example including pipe unit 81 having a wall thickness of 0.5 mm, and that of the residual magnetic field corresponding to an inventive example including the pipe unit having a wall thickness of 1 mm, respectively. This result has revealed that the inventive examples have reduced the residual magnetic field more than the comparative example. Furthermore, it has also been found that pipe unit 81 having the wall thickness of 0.5 mm is also effective and that pipe unit 81 having the wall thickness of 1 mm is more effective.

### Example 2

An inventive example corresponding to the second embodiment (i.e., having pipe unit 81 shown in FIG. 7) and a comparative example (excluding pipe unit 81) provided residual magnetic fields, respectively, through a simulation in the finite element method, as will be described hereinafter. In the simulation, double pancake coil 11 (see FIG. 4) had an inner diameter of 200 mm, an outer diameter of 280 mm, a height of 10 mm, and 290 turns. Furthermore, coil unit 10 (see FIG. 2) had 20 double pancake coils 11 stacked in layers. Furthermore, heat exchanger plate 31 had a thickness of 1 mm. Pipe unit 81 was assumed to be formed of SS400 (according to JIS). Furthermore, pipe unit 81 had an outer diameter of 150 mm and a length of 480 mm. Furthermore, it was assumed that cooling device 121 (see FIG. 1) cools coil unit 10 to a temperature of 20 K, and a current in the ON state was assumed to be 225 A. A magnetic field in the ON state was set to 5 T.

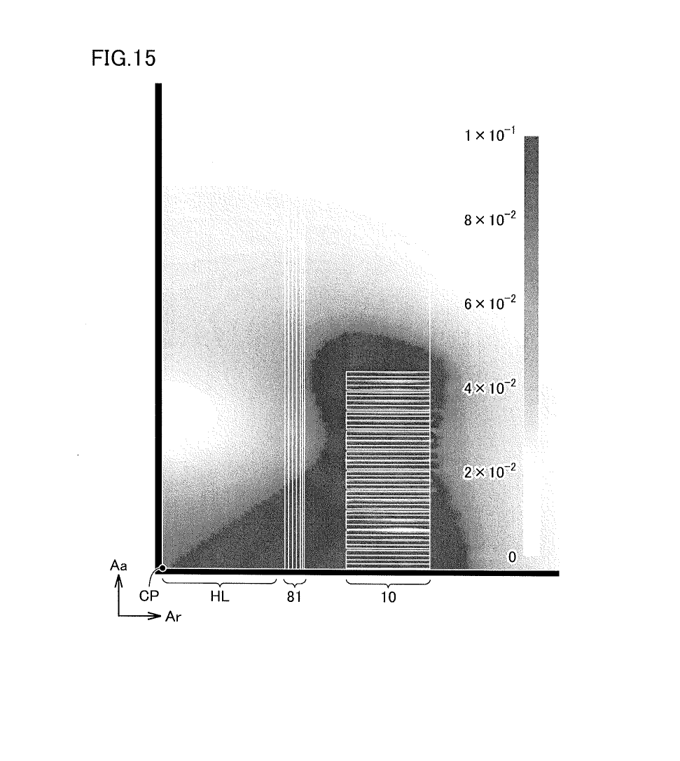

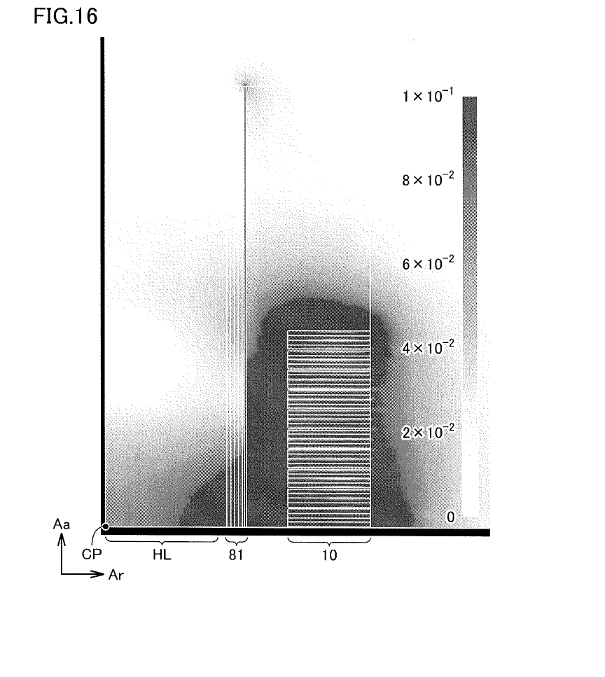

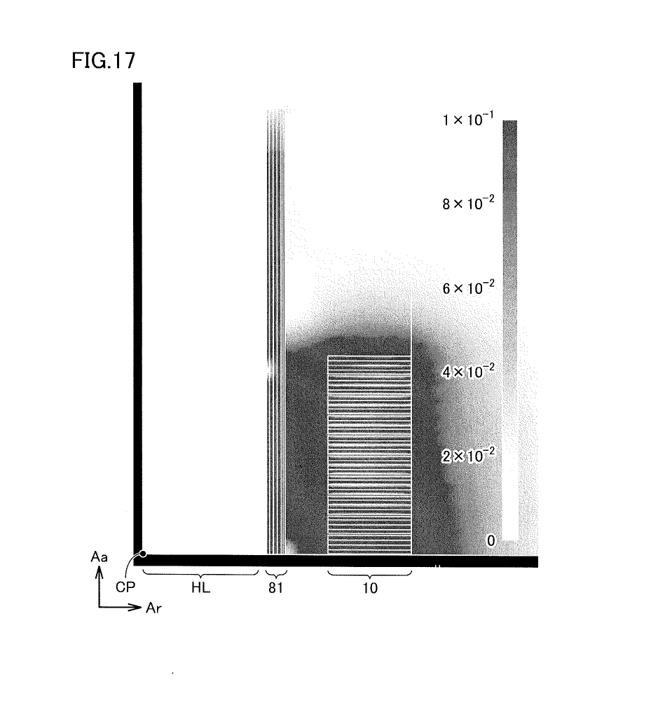

FIGS. 15, 16 and 17 represent a distribution of residual magnetic field (T) corresponding to the comparative example (excluding the pipe), that of the residual magnetic field corresponding to an inventive example including pipe unit 81 having a wall thickness of 1 mm, and that of the residual magnetic field corresponding to an inventive example including the pipe unit having a wall thickness of 10 mm, respectively. This result has revealed that the inventive examples have reduced the residual magnetic field more than the comparative example. Furthermore, it has also been found that pipe unit 81 having the wall thickness of 1 mm is also effective and that pipe unit 81 having the wall thickness of 10 mm is more effective.

### Example 3

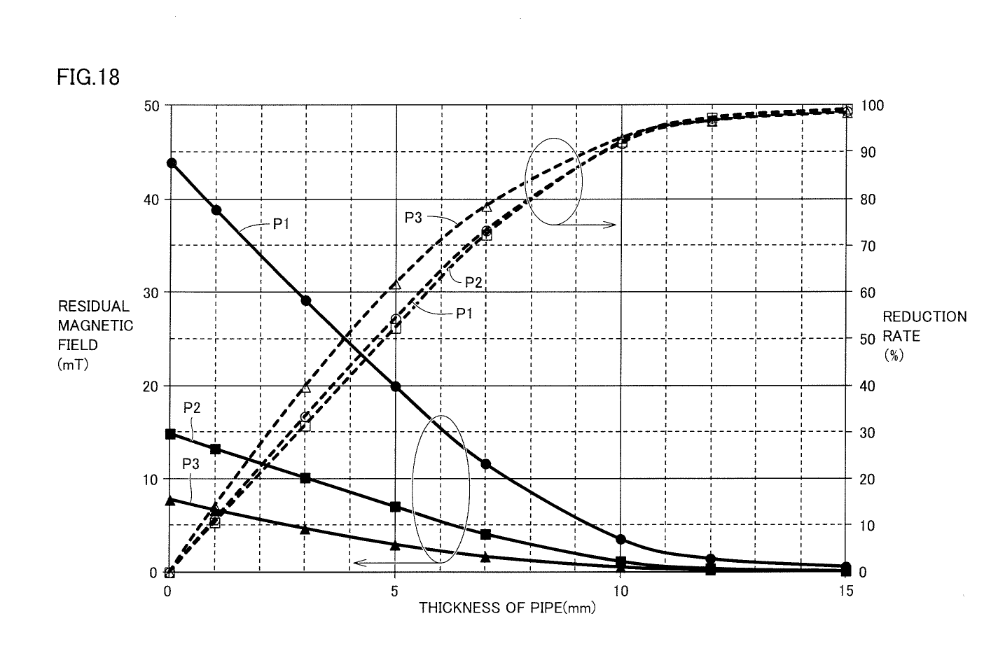

With reference to FIG. 18, an inventive example corresponding to the second embodiment was subjected to a simulation in the finite element method for a residual magnetic field in magnitude, as represented along the left vertical axis, and a residual magnetic field reduction rate attributed to pipe unit 81, as represented along the right vertical axis, versus pipe unit 81 in thickness, as represented along the horizontal axis. The graph indicates lines P1-P3, which correspond to positions P1-P3 shown in FIG. 7. In other words, position P1 is the coil's center position, position P2 is the position of an end of superconducting coil 91A, and position P3 is the position of an end of pipe unit 81. From this result, it has been found that positions P1-P3 all had a reduced residual magnetic field. Furthermore, the inventive example for example with the thickness of 1 mm or larger provided a significant reduction effect of a reduction rate of 10% or larger. Furthermore, the inventive example with pipe unit 81 having the thickness of approximately 10 mm or larger provided a substantially saturated residual magnetic field reduction rate.

### Example 4

With reference to a table 1 below, the second embodiment with cooling device 121 operated to allow the coil to be operated at a temperature of 77 K to be suitable for generating a relatively less intense magnetic field, and the second embodiment with cooling device 121 operated to allow the coil to be operated at a temperature of 20 K to be suitable for generating a relatively intense magnetic field were subjected as inventive examples to a simulation, and provided a result, as indicated hereinafter. Note that the table also indicates a result of a comparative example excluding pipe unit 81.

TABLE 1

| | | |
|---|---|---|
| Temperature | 77 K | 20 K |

| | | | | |
|---|---|---|---|---|
| ON magnetic field | 0.63 | T | 5.1 | T |
| residual magnetic field | 6.8 | mT | 83 | mT |
| (comparative example) | | | | |

| | | |
|---|---|---|
| residual magnetic field | 0.52 mT (reduced | 4.5 mT (reduced |
| (inventive example) | by 92%) | by 95%) |

| | | | | |
|---|---|---|---|---|
| thickness of pipe | 1 | mm | 10 | mm |

From this result it has been found that a thickness that pipe unit 81 is required to have to remove a major portion of a residual magnetic field significantly depends on the magnitude of a magnetic field generated by superconducting magnet 100A (see FIG. 7) in an ON state (or an ON magnetic field). More specifically, it has been found that for an ON magnetic field smaller than 1 T, a thickness of approximately 1 mm allows the major portion of the residual magnetic field to be removed, and that for an ON magnetic field equal to or larger than 5 T, a thickness of approximately 10 mm allows the major portion of the residual magnetic field to be removed.

It should be understood that the embodiments and examples disclosed herein have been described for the purpose of illustration only and in a non-restrictive manner in any respect. The scope of the present invention is defined by the terms of the claims, rather than the embodiments described above, and is intended to include any modifications within the meaning and scope equivalent to the terms of the claims.

### REFERENCE SIGNS LIST

10: coil unit; 11: double pancake coil; 12a, 12b: pancake coil; 14: oxide superconducting wire; 20: cooling head; 31: heat exchanger plate; 81: pipe unit (residual magnetic field restraint unit); 81a: inner circumference pipe (first portion); 81b: outer circumferential pipe (second portion); 91, 91A: superconducting coil; 100, 100A-100E: superconducting magnet; 111, 111D: thermal insulation container; 121: cooling device; 123: compressor; 132: power supply; SC: magnetic field application region; SF: surface in a form of a strip.

1. A superconducting magnet comprising:
a coil unit formed of an oxide superconducting wire having a surface in a form of a strip and wound; and
a residual magnetic field restraint unit formed of a magnetic substance, disposed in said coil unit, and having a throughhole extending in an axial direction of said coil unit.

2. The superconducting magnet according to claim 1, wherein said magnetic substance has a maximum magnetic permeability equal to or larger than 100.

3. The superconducting magnet according to claim 1, wherein said residual magnetic field restraint unit has a length in said axial direction equal to or larger than a width of said surface in the form of said strip of said oxide superconducting wire.

4. The superconducting magnet according to claim 1, wherein said residual magnetic field restraint unit has a length in said axial direction equal to or larger than a half of a length of said coil unit in said axial direction.

5. The superconducting magnet according to claim 1, wherein said residual magnetic field restraint unit has a length in said axial direction equal to or larger than a length of said coil unit in said axial direction.

6. The superconducting magnet according to claim 1, wherein said residual magnetic field restraint unit has a length in said axial direction larger than a length of said coil unit in said axial direction.

7. The superconducting magnet according to claim 1, wherein said residual magnetic field restraint unit includes a pipe having a wall thickness equal to or larger than 1 mm.

8. The superconducting magnet according to claim 1, wherein said residual magnetic field restraint unit has a first portion having said throughhole, and a second portion spaced from said first portion and surrounding said first portion.

9. The superconducting magnet according to claim 1, wherein said residual magnetic field restraint unit configures a portion of a container that accommodates said coil unit therein.

10. The superconducting magnet according to claim 1, wherein in at least one radial direction of said coil unit, said coil unit and said residual magnetic field restraint unit have a common center position.

11. The superconducting magnet according to claim 1, wherein in said axial direction of said coil unit, said coil unit and said residual magnetic field restraint unit have a common center position.

12. The superconducting magnet according to claim 1, further comprising a shield formed of a magnetic substance and having a hollow portion to accommodate said coil unit therein, wherein in at least one radial direction of said coil unit, said coil unit and said shield have a common center position.

13. The superconducting magnet according to claim 1, further comprising a shield formed of a magnetic substance and having a hollow portion to accommodate said coil unit therein, wherein in said axial direction of said coil unit, said coil unit and said shield have a common center position.
